(19) United States
(12) Patent Application Publication
(10) Pub. No.: US 2010/0229525 A1
(43) Pub. Date: Sep. 16, 2010

(54) TURBINE COMBUSTION AIR SYSTEM

(76) Inventors: Robin Mackay, Mammoth Lakes, CA (US); James Lenertz, Scondale, AZ (US); Daniel Bakholdin, Valncia, CA (US)

Correspondence Address: Ocean Law, 3463 RED BLUFF CT., Simi Valley, CA, 93063, US

(21) Appl. No.: 12/699,817

(22) Filed: Feb. 3, 2010

Related U.S. Application Data
(60) Provisional application No. 61/160,301, filed on Mar. 14, 2009.

(51) Int. Cl. F02C 7/10

(52) U.S. Cl. 60/39.511

(57) ABSTRACT

A turbine combustion air system includes a recuperator and a multi-zone combustor for accepting multiple combustion air streams at multiple temperatures.

### PRIORITY CLAIM

This application claims the benefit of U.S. Provisional Patent Application No. 61/160,301 for RECUPERATOR BYPASS TO COMBUSTOR PRIMARY ZONE filed Mar. 14, 2009.

### BACKGROUND OF THE INVENTION

1. Field of the Invention

The present invention relates to a Brayton cycle machine. In particular, a combustion turbine includes a new and useful combustion air system.

2. Discussion of the Related Art

Combustion turbines typically have combustors located between a turbine section and a compressor section. These combustors typically receive combustion air from the compressor section and fuel from a fuel source. Fuel and combustion air mixed in the combustor provide a flammable mixture that is ignited to produce hot gases that expand across and drive the turbine section.

Efficiency improvements in combustion turbines include recovery of energy from the hot gases exhausted from the turbine section. Small combustion turbines with relatively low compressor outlet pressures and air flow rates have used recuperators to capture exhaust energy to preheat compressor discharge air. Large combustion turbines with relatively high compressor outlet pressures and air flow rates typically add a Rankine cycle machine to utilize recovered exhaust gas energy as this avoids large pressure differentials across large heat exchanger surfaces.

Combustion air for turbine combustors is typically supplied directly from the compressor in large turbines. In smaller turbines, the combustion air is typically supplied either directly from the compressor or, where there is a recuperator, from a high pressure recuperator outlet.

### SUMMARY OF THE INVENTION

In the present invention, a combustion turbine has a combustion air system including a recuperator and a multi-zone combustor. In an embodiment, the turbine combustion air system comprises a compressor and combustor connected via a first fluid circuit. An included recuperator has a heating passage and a cooling passage with the heating passage forming a part of the first fluid circuit for preheating compressor discharge air. The first fluid circuit is operable to deliver pre-heated air to a combustor dilution air inlet and a second fluid circuit connects the compressor and the combustor. The second fluid circuit bypasses the heating passage and operates to deliver air to a combustor primary air inlet. A third fluid circuit connects the combustor and the cooling passage and a turbine forms a part of the third fluid circuit for expanding combustion products such that the third fluid circuit is operable to deliver turbine exhaust to a cooling passage inlet.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 shows a prior art combustion turbine system.

FIG. 2 shows a prior art combustion turbine system with a recuperator.

FIG. 3 is a first combustion turbine system in accordance with the present invention.

FIG. 4A is a second combustion turbine system in accordance with the present invention.

FIG. 4B is a third combustion system in accordance with the present invention.

FIG. 5 is a fourth combustion turbine system in accordance with the present invention.

### DETAILED DESCRIPTION OF THE PREFERRED EMBODIMENTS

The disclosure provided in the following pages describes examples of some embodiments of the invention. The designs, figures, and description are non-limiting examples of the embodiments they disclose. For example, other embodiments of the disclosed device and/or method may or may not include the features described herein. Moreover, disclosed advantages and benefits may apply to only certain embodiments of the invention and should not be used to limit the disclosed invention.

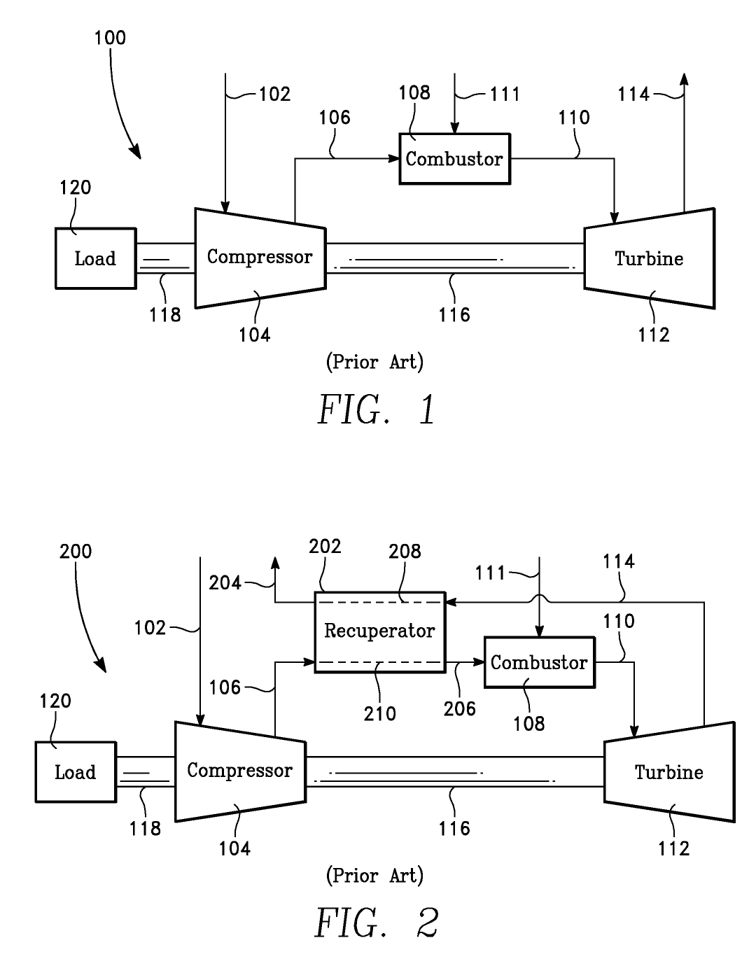

FIG. 1 shows a prior art combustion turbine system without turbine exhaust gas heat recovery 100. Arranged as an open cycle machine, the combustion turbine includes a compressor 104, a combustor 108, a turbine 112, and a first interconnecting shaft 116 for transferring turbine work to the compressor. The combustion turbine drives a load such as an electric generator 120 via a second interconnecting shaft 118 coupling the compressor to the load.

The combustor 108 is located between the compressor 104 and the turbine 112. Air drawn from a compressor inlet 102 is compressed and discharged to a compressor outlet 106 that is coupled to the combustor. A fuel supply line 111 provides fuel to the combustor. As used herein, the term inlet refers to one or more of a device inlet and/or a line coupled with the device inlet. Similarly, the term outlet refers to one or more of a device outlet and/or a line coupled with the device outlet.

Combustion of a fuel/air mixture produces gaseous combustion products that flow from the combustor 108 to the turbine 112 through a turbine inlet 110. Combustion gases expand as they pass through the turbine and the expanded gases leave the turbine through a turbine exhaust 114.

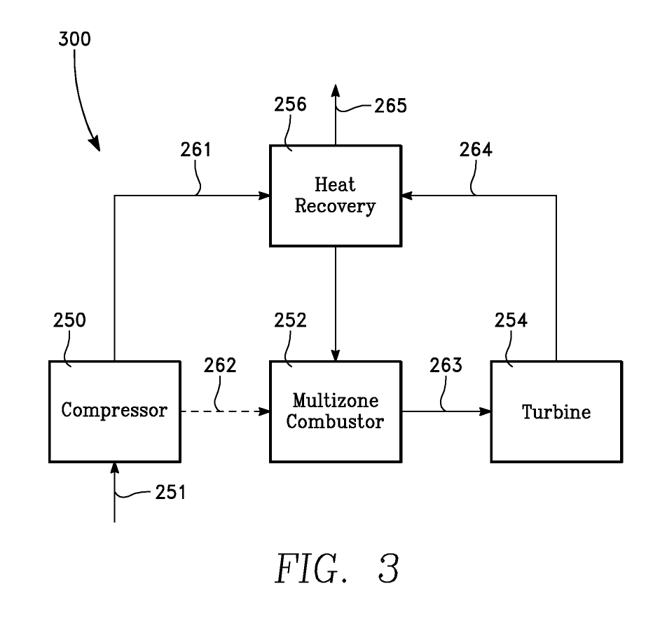

FIG. 2 shows a prior art combustion turbine system with turbine exhaust gas heat recovery 200. Arranged as an open cycle machine, the combustion turbine includes a compressor 104, a combustor 108, a turbine 112, a heat exchanger or recuperator 202, and a first interconnecting shaft 116 for transferring turbine work to the compressor. The combustion turbine drives a load such as an electric generator 120 via a second interconnecting shaft 118 coupling the compressor to the load.

A combustor 108 is located between the recuperator 202 and the turbine 112. Air drawn from a compressor inlet 102 is compressed and discharged to a high pressure inlet 106 of the recuperator. Air heated by the recuperator in recuperator heating passages 210 is discharged at a recuperator high pressure outlet 206 that is coupled to the combustor 108. A fuel supply line 111 provides fuel to the combustor.

Combustion of a fuel/air mixture produces gaseous combustion products that flow from the combustor 108 to the turbine 112 through a turbine inlet 110. Combustion gases expand as they pass through the turbine and the expanded gases leave the turbine through a turbine exhaust 114 that is coupled to a low pressure inlet of the recuperator. Combustion gases cooled by the recuperator in recuperator cooling passages 208 are discharged at a recuperator low pressure outlet 204.

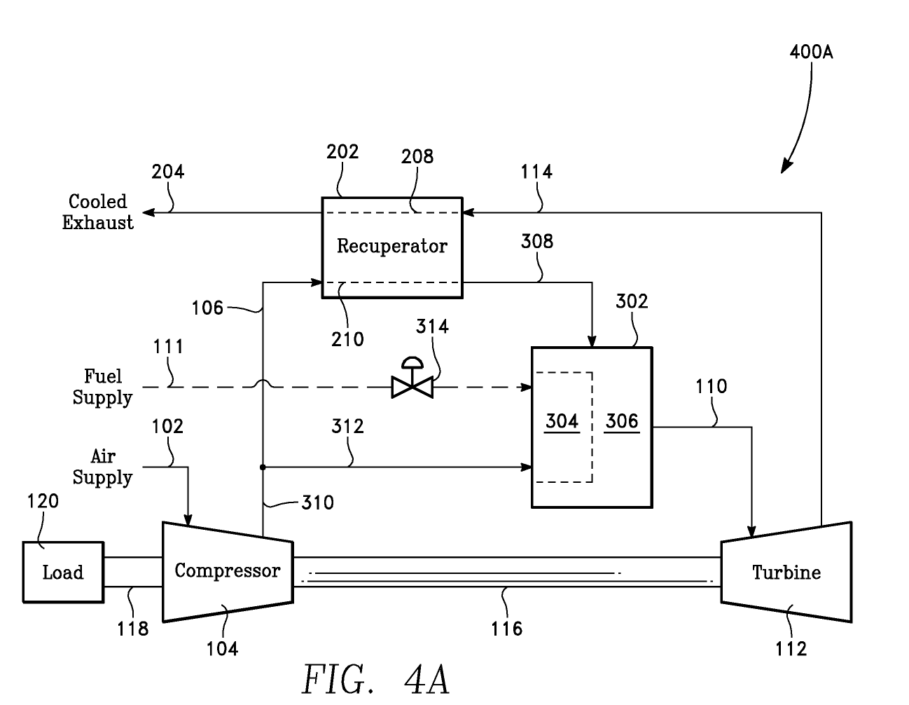

FIG. 3 shows a combustion turbine system with turbine exhaust gas heat recovery and a multi-zone combustor in accordance with an embodiment of the present invention 300. The combustion turbine system includes a compressor 250, a multi-zone combustor 252, a turbine 254, and a heat recovery device 256.

Gas enters the compressor 250 via a compressor gas inlet 251. Compressed gas from the compressor supplies the heat recovery device 256 via a first line 261 and optionally supplies the multi-zone combustor 252 via a second line 262. The turbine 254 receives combustion products from the multi-zone combustor via a third line 263 and exhausts to the heat recovery device via a fourth line 264. Cooled combustion products leave the heat recovery device via an exhaust line 265. In various embodiments, other devices such as flow restrictors and heat exchangers are interposed in one or more lines.

In various embodiments, other equipment such as heat exchangers, filters, valves, and bleeds is associated with one or more of the compressor inlet, compressor discharge, turbine inlet and turbine exhaust. Exemplary turbine system arrangements including one or more of these items of equipment are found below.

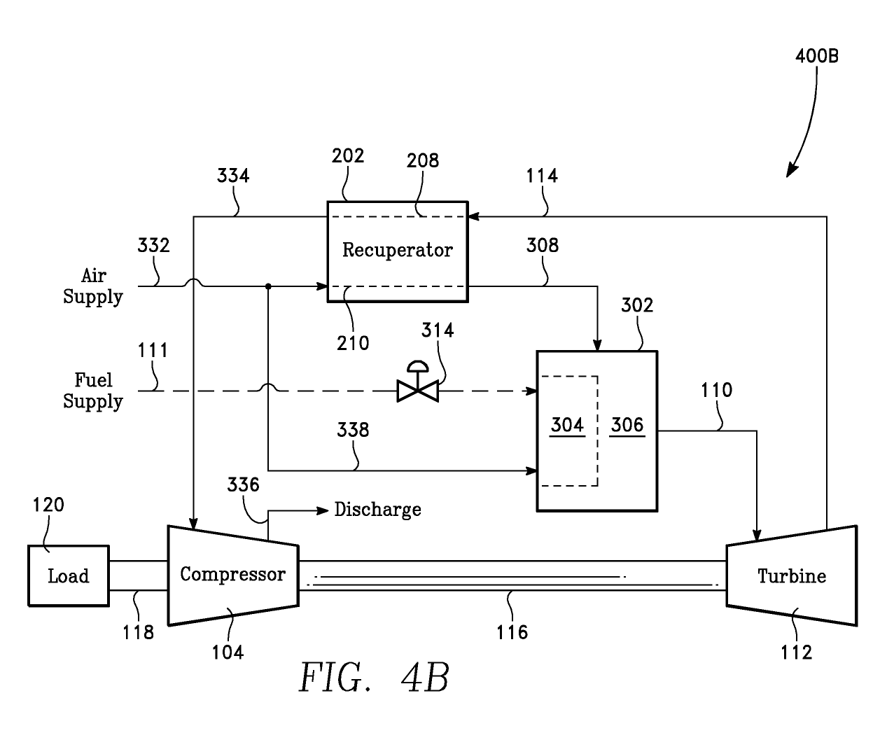

FIG. 4A shows a combustion turbine system with turbine exhaust gas heat recovery and a multi-zone combustor in accordance with an embodiment of the present invention 400A. Arranged as an open cycle machine, the combustion turbine includes a compressor 104, a combustor 302, a turbine 112, a heat exchanger or recuperator 202, and a first interconnecting shaft 116 for transferring turbine work to the compressor.

In various embodiments, the combustion turbine drives a load such as an electric generator 120 via a second interconnecting shaft 118 coupling the compressor 104 to the load. In other embodiments, an interconnecting shaft couples the turbine to a load.

In various embodiments, turbine 112 includes multiple turbines at least one of which has no direct/shaft connection to the compressor 104. Such “free-turbine” arrangements are commonly found in aircraft engines.

Combustor 302 is a multi-zone combustor including a primary air zone 304 and a dilution air zone 306. The primary air zone is capable of receiving combustion air from a primary zone air inlet 312 and the dilution air zone is capable of receiving combustion air from a dilution air zone inlet 308.

Air drawn from a compressor inlet 102 is compressed and discharged via a compressor discharge 310 to a recuperator high pressure inlet 106 and the combustor primary zone inlet 312. Air heated by the recuperator in recuperator heating passages 210 flows to the combustor 302 via the combustor dilution air inlet 308. A fuel supply line 111 and fuel control valve 314 provide fuel to the combustor.

Ignition of a fuel/air mixture in the combustor primary zone produces gaseous combustion products that mix with dilution air from the dilution air zone 306. These gases flow from the combustor 302 to the turbine 112 through a turbine inlet 110. Combustion gases expand as they pass through the turbine and the expanded gases leave the turbine through a turbine exhaust 114 that is coupled to a low pressure inlet of the recuperator. Combustion gases cooled by the recuperator in recuperator cooling passages 208 are discharged at a recuperator low pressure outlet 204.

FIG. 4B shows a combustion turbine system with turbine exhaust gas heat recovery and a multi-zone combustor in accordance with an embodiment of the present invention 400B. Arranged as an open cycle machine, the combustion turbine includes a compressor 104, a combustor 302, a turbine 112, a heat exchanger or recuperator 202, and a first interconnecting shaft 116 for transferring turbine work to the compressor.

In various embodiments, the combustion turbine drives a load such as an electric generator 120 via a second interconnecting shaft 118 coupling the compressor 104 to the load. In other embodiments, an interconnecting shaft couples the turbine 112 to a load.

In various embodiments, turbine 112 includes multiple turbines at least one of which has no direct/shaft connection to the compressor 104. Such “free-turbine” arrangements are commonly found in aircraft engines.

Combustor 302 is a multi-zone combustor including a primary air zone 304 and a dilution air zone 306. The primary air zone is capable of receiving combustion air from a primary zone air inlet 338 and the dilution air zone is capable of receiving combustion air from a dilution air zone inlet 308.

An air supply provides air to recuperator passages 210 via recuperator air inlet 332 and to the combustor primary zone 304 via primary zone inlet 338. In some embodiments the air supply is ambient air such that the combustor 302 operates at a pressure below ambient air pressure. In an embodiment, the air is supplied from a fan discharge at a pressure above ambient air pressure.

Air heated by the recuperator in recuperator heating passages 210 flows to the combustor 302 via the combustor dilution air inlet 308. A fuel supply line 111 and fuel control valve 314 provide fuel to the combustor.

Ignition of a fuel/air mixture in the combustor primary zone produces gaseous combustion products that mix with dilution air from the dilution air zone 306. These gases flow from the combustor 302 to the turbine 112 through a turbine inlet 110. Combustion gases expand as they pass through the turbine and the expanded gases leave the turbine through a turbine exhaust 114 that is coupled to recuperator cooling passages 208. Combustion gases cooled by the recuperator in the recuperator cooling passages flow to a compressor 104 via a compressor inlet 334. Pressurized combustion gases leave the compressor via a compressor discharge 336. In some embodiments, the compressor discharges combustion gases directly to ambient. In an embodiment, the discharge is coupled to an inlet of a fan.

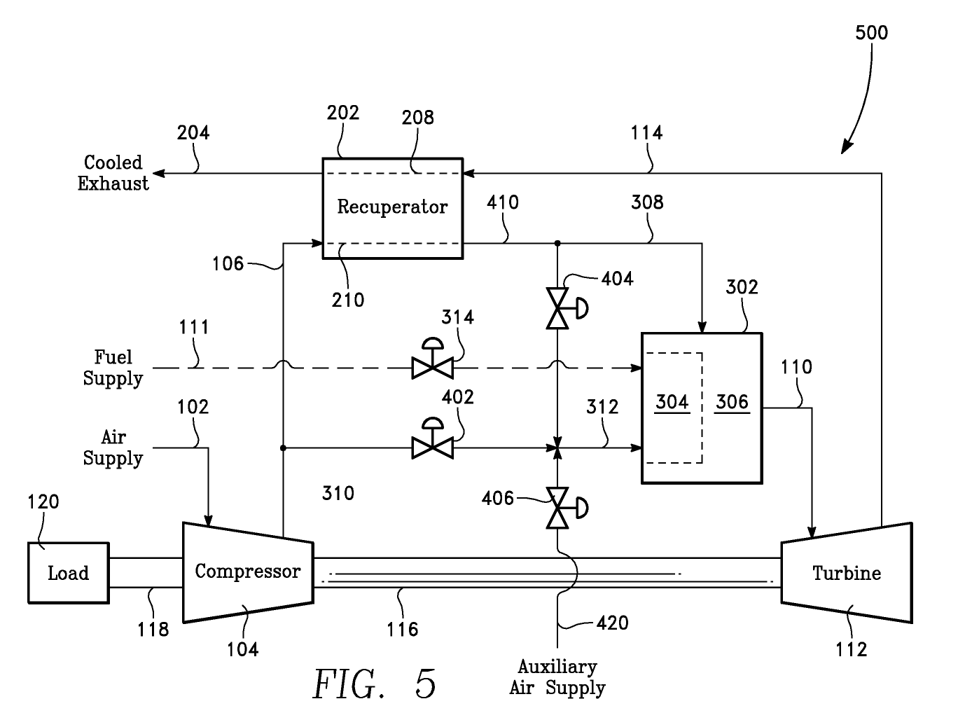

FIG. 5 shows a combustion turbine system with turbine exhaust gas heat recovery and a multi-zone combustor 500. In this embodiment, primary air is available from any of a compressor discharge 310, a recuperator heating passage outlet 410, and an auxiliary air source 420. Respective control valves 402, 404, and 406 enable selection of varying amounts of air from each source.

In an operating mode, valves 402 and 404 are closed while valve 406 is open such that auxiliary air is supplied from an auxiliary source. Auxiliary sources include auxiliary compressors, air tanks, and air available from a truck braking system. For example, where truck braking system air is warmer than ambient air, this operating mode provides more favorable conditions for combustion turbine starting.

In another operating mode, valves 402 and 406 are closed while valve 404 is open such that primary air is pre-heated air supplied from the recuperator 202. For example, where combustion turbine load is reduced, this operating mode provides increased efficiency and reduced environmental impact through increased waste heat recovery and reduced carbon monoxide and unburned hydrocarbon emissions.

In yet another operating mode, valves 406 and 404 are closed while valve 402 is open such that primary air bypasses the recuperator 202. For example, where combustion turbine load is moderate to high, this operating mode provides reduced nitrous oxide (“NOx”) emissions.

In operation, combustion of fuel in the combustor 302 provides hot, high pressure gases to the turbine inlet 110. Expansion of these gases across the turbine rotates the turbine, compressor, and load via interconnecting shafts 116, 118. In the case the load is an electric generator, electrical interconnection of the generator with electric power consumers provides a means for utilizing the generated power.

Where it is desirable to operate a combustion turbine system at high efficiency while lowering nitrous oxide (NOx) emissions, arrangements including a recuperator and a multi-zone combustor offer advantages. Because heated air is available from the recuperator heated air outlet 308 and relatively cool air is available from the compressor discharge 310 or air supply via recuperator air inlet 332, a multi-zone combustor can utilize the cool air in a primary zone 304 while maintaining high efficiency through use of hot air in a dilution zone 306.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A turbine combustion air system comprising:
a compressor and combustor connected via a first fluid circuit;
a recuperator including a heating passage and a cooling passage;
the heating passage forming a part of the first fluid circuit for preheating compressor discharge air;
the first fluid circuit operable to deliver pre-heated air to a combustor dilution air inlet;
a second fluid circuit connecting the compressor and the combustor, the second fluid circuit bypassing the heating passage and operable to deliver air to a combustor primary air inlet;
a third fluid circuit connecting the combustor and the cooling passage;
a turbine forming a part of the third fluid circuit for expanding combustion products; and,
the third fluid circuit operable to deliver turbine exhaust to a cooling passage inlet.

2. A turbine combustion air system comprising:
a compressor and combustor connected via a first fluid circuit;
a recuperator including a heating passage and a cooling passage;
the heating passage forming a part of the first fluid circuit for preheating compressor discharge air;
the first fluid circuit operable to deliver pre-heated air to a combustor dilution air inlet;
an auxiliary fluid circuit connecting an auxiliary air source and the combustor, the auxiliary fluid circuit bypassing the heating passage and operable to deliver air to a combustor primary air inlet;
a third fluid circuit connecting the combustor and the cooling passage;
a turbine forming a part of the third fluid circuit for expanding combustion products; and,
the third fluid circuit operable to deliver turbine exhaust to a cooling passage inlet.

3. A turbine combustion air system comprising:
a compressor and combustor connected via a first fluid circuit;
a recuperator including a heating passage and a cooling passage;
the heating passage forming a part of the first fluid circuit for preheating compressor discharge air;
the first fluid circuit operable to deliver pre-heated air to a combustor dilution air inlet;
three control valves having respective inlets coupled to a compressor discharge, a recuperator heating passage discharge, and an auxiliary air source;
the three control valves emptying into a common manifold operable to deliver air to a combustor primary inlet;
a third fluid circuit connecting the combustor and the cooling passage;
a turbine forming a part of the third fluid circuit for expanding combustion products; and,
the third fluid circuit operable to deliver turbine exhaust to a cooling passage inlet.
